(19) United States
(12) Patent Application Publication
(10) Pub. No.: US 2005/0188457 A1
(43) Pub. Date: Sep. 1, 2005

(54) Electrically heated bathtub

(76) Inventor: Justin C. Turner, Hampton, VA (US)

Correspondence Address: Richard C. Litman;LITMAN LAW OFFICES, LTD., P. O. Box 15035, Arlington, VA, 22215, US

(21) Appl. No.: 10/788,345

(22) Filed: Mar. 1, 2004

(51) Int. Cl. A61H 33/02; A47K 3/02

(52) U.S. Cl. 4/545

(57) ABSTRACT

An electrically heated bathtub, with an inside wall, an outside wall and a bottom floor, the inside wall having an outer surface and an inner surface, the outside wall having an outer surface and an inner surface and the bottom floor having an outside bottom surface and an inside bottom surface. A heating element is attached to the outer surface of the inside wall and conductively heats the inner surface of the inside wall, which in turn heats any water that might be in the bathtub without the heating element being exposed or protruding through any surfaces. The heating element is also attached to the outer bottom surface of the bottom floor and conductively heats the inner bottom surface of the bottom floor, with the heating element spread evenly throughout the outer bottom surface of the bottom floor.

### BACKGROUND OF THE INVENTION

1. Field of the Invention

The present invention relates to a bathtubs, and more particularly to an electrically heated bathtub.

2. Description of the Related Art

Heated bathtubs and spas are luxurious items that are very popular in modern homes and condos. These bathtubs and spas are provided with heat from a variety of energy sources, such as electricity, coal and natural gas. This wide variety of bathtubs and spas is also reflected in the related art.

U.S. Pat. No. 4,150,665, issued to Wolfson on Apr. 24, 1979, teaches the use of a heater for use with a hot tub formed from material subject to damage from excessive heat, the heater having a heating element arranged within a chamber adjacent a thermally conductive plate with one or more hollow extensions penetrating through a surface portion of the hot tub to permit direct heat transfer between the thermally conductive plate and the hot tub interior.

U.S. Pat. No. 4,385,724, issued to Ramsauer et al. on May 31, 1983, describes a temperature sensing and control apparatus for a spa. Switches are disposed in the series electrical circuit of a water heating mechanism. The switches are also remotely controlled as a function of the water temperature and operate in a low voltage and low current range, thereby minimizing a safety hazard.

U.S. Pat. No. 4,409,694, issued to Barrett, Sr. et al. on Oct. 18, 1983, discloses an electronic device for controlling the temperature of a liquid, such as water flowing into a container, such as a bathtub. The device also controls the level of liquid within the container and includes a solid-state circuit in conjunction with a temperature-sensing device for maintaining the temperature of the liquid.

U.S. Pat. No. 4,455,997, issued to Evans et al. on Jun. 26, 1984, shows a submerged heating unit fueled by wood and/or coal for heating water in a tub or spa unit. The heating unit has a single shell of a highly heat-conductive metal, such as aluminum, and has a generally L-shaped configuration in cross-section. The unit is entirely submerged in the tank of water except for air and fuel inlets and an exhaust outlet.

U.S. Pat. No. 4,780,917, issued to Hancock on Nov. 1, 1988, describes an exteriorly installed therapeutic spa with a water circulation loop that includes an electric heater for heating the water, an electric motor-driven pump for circulating the water at low and high speeds and an electric motor-operated blower for injecting air into the water.

U.S. Pat. No. 5,433,379, issued to Harrison on Jul. 18, 1995, teaches the use of a dual tank heating system that has an exterior tank, which surrounds an interior tank. Water in the exterior tank is maintained at a prescribed temperature by heating elements located beneath the outer tank. Water in the interior tank is heated by water in the exterior tank and, when necessary, may be heated by a secondary heating element located beneath the interior tank.

U.S. Pat. No. 5,559,720, issued to Tompkins et al. on Sep. 24, 1996, discloses a spa control system, which calculates the time required to heat the water in the spa system to a desired temperature. From that information, the heating rate of the spa system can be determined and the heating element of the spa system can be activated at the proper time to raise the temperature of the water to a selected temperature by a desired time.

U.S. Pat. No. 5,649,330, issued to Lind on Jul. 22, 1997, shows a self-heating outdoor bathtub to simulate a natural hot spring pool. Major components are salvaged from discarded water heaters along with its inconspicuous appearance, low value and durability, eases concerns of theft or vandalism. There is also a water-heated unit and a flexible tarp, serving as a bathing container, joined by an open water passage between the two.

U.S. Pat. No. 6,591,063, issued to Rochelle on Jul. 8, 2003, describes a temperature maintenance heater assembly for maintaining the temperature of a heated fluid circulating through the piping of a bath, including a pipe section, a base plate, a control device assembly, a base plate cover and a heating element. The pipe section has an outer wall, an inlet and an outlet, while the control device assembly has a first and second control switch, wherein each of the first and second pressure switches have first and second electric terminals and pressure sensors and switch mechanisms.

U.S. Pat. No. 6,643,454, issued to Rochelle on Nov. 4, 2003, teaches a temperature maintenance heater assembly for maintaining the temperature of a heated fluid circulating through piping of a bath, that includes a pipe section, a base plate, a control assembly, a heater assembly cover and a heating element. The heater element is mounted within the pipe section and the control device assembly is electrically connected to the heater element and to a source of power.

International Pat. No. WO 01/69141, published on Sep. 20, 2001, discloses a heated bathing tub provided with a fire chamber to form an integrated unit to be moved as a whole. The fire chamber is used for heating the water in the bathing tub and is surrounded by water in such a way that there is a connection from the outside with the fire chamber in order to supply fuel into the fire chamber through an aperture made in the side wall of the bathing tub.

There is a need for a heated bathtub or spa that is simple in design and can be easily used with a common electrical outlet. Such a bathtub or spa would be well received in the marketplace and would be easier to use than bathtubs and spas currently used in the marketplace.

None of the above inventions and patents, taken either singly or in combination, is seen to describe the instant invention as claimed. Thus an electrically heated bathtub solving the aforementioned problems is desired.

### SUMMARY OF THE INVENTION

The present invention is an electrically heated bathtub. The bathtub has an inside wall, an outside wall and a bottom floor, the inside wall having an outer surface and an inner surface, the outside wall having an outer surface and an inner surface, and the bottom floor having an outside bottom surface and an inside bottom surface. A heating element is attached to the outer surface of the inside wall and conductively heats the inner surface of the inside wall, which in turn heats any water that might be in the bathtub without the heating element being exposed or protruding into the tub. The heating element is also attached to the outer bottom surface of the bottom floor and conductively heats the inner bottom surface of the bottom floor, with the heating element spread evenly throughout the outer bottom surface of the bottom floor.

Accordingly, it is a principal object of the invention to provide a heated bathtub or spa that is easier to install than currently available heated bathtubs and spas.

It is another object of the invention to provide an electrically powered heated bathtub or spa that is safe to use.

It is a further object of the invention to provide a heated bathtub or spa that is easier to use than currently available heated bathtubs and spas.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an electrically heated bathtub according to the present invention.

FIG. 2 is a top plan view of the electrically heated bathtub of the present invention.

FIG. 3 is a section view along lines 3-3 of FIG. 2.

Similar reference characters denote corresponding features consistently throughout the attached drawings.

### DETAILED DESCRIPTION OF THE PREFERRED EMBODIMENT

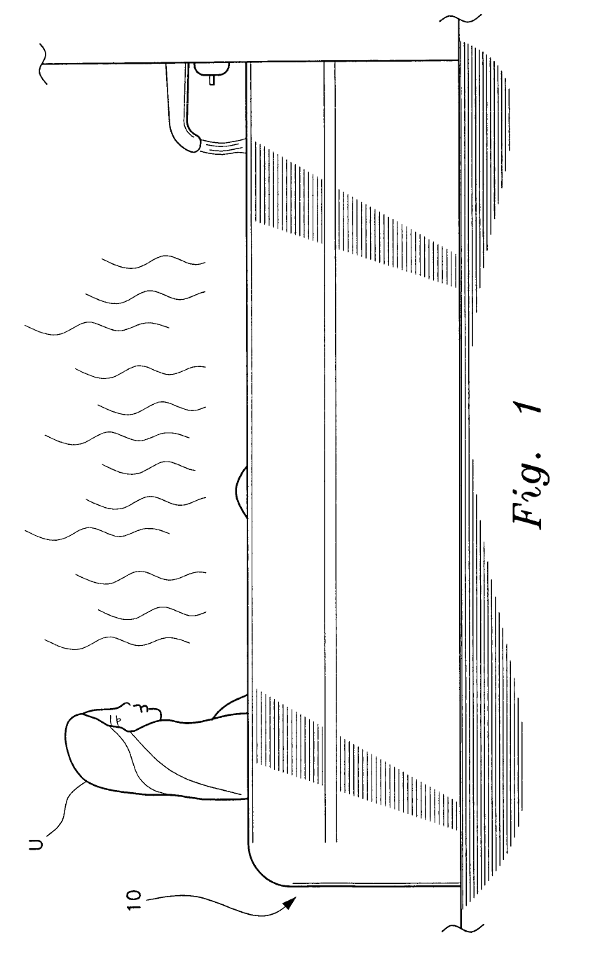

The present invention is an electrically heated bathtub 10, shown in use by a user U in FIG. 1.

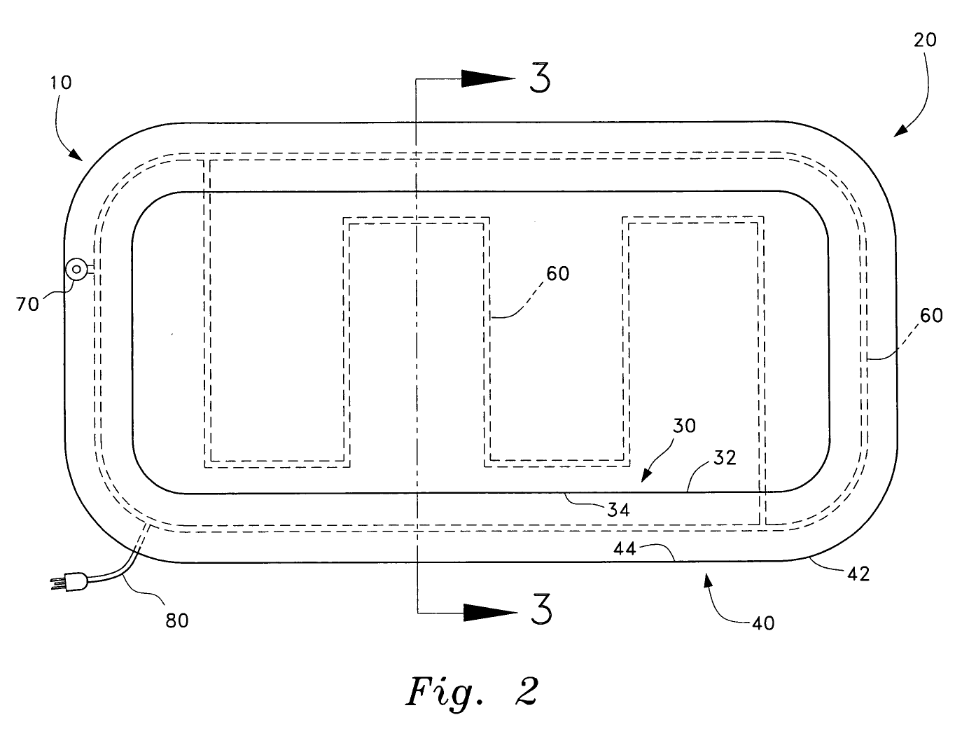

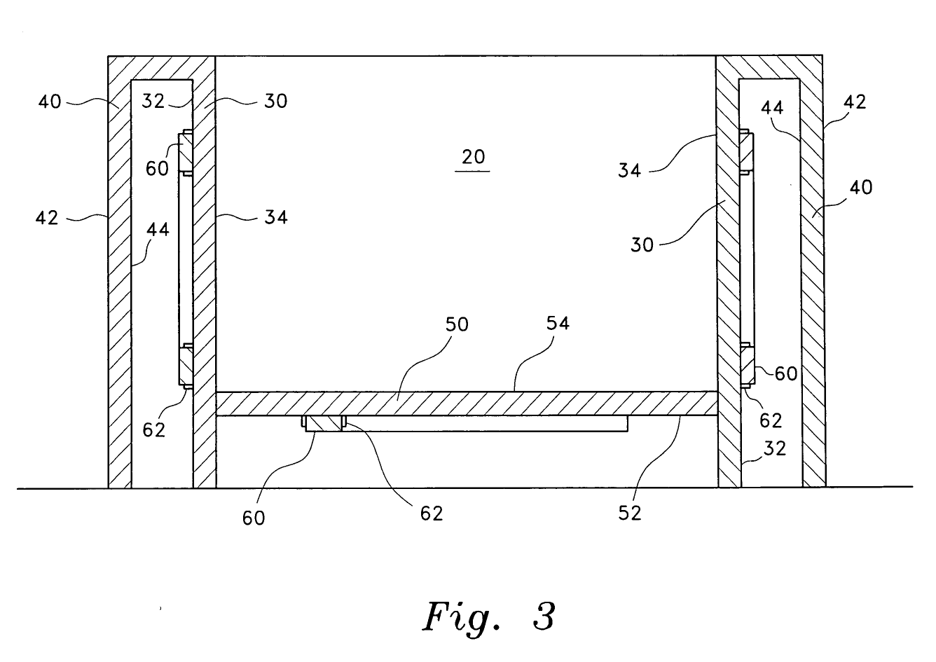

As depicted in FIG. 2 and FIG. 3, the electrically heated bathtub 10 comprises a bathtub 20 with an inside wall 30, an outside wall 40 and a bottom floor 50, the inside wall 30 having an outer surface 32 and an inner surface 34, the outside wall 40 having an outer surface 42 and an inner surface 44 and the bottom floor 50 having an outer bottom surface 52 and an inner bottom surface 54. The electrically heated bathtub 10 further comprises a heating element 60 that is attached to the outer surface 32 of the inside wall 30 by clips 62, brackets, or the like, and conductively heats the inner surface 44 of the inside wall 40, which in turn heats any water (not shown) that might be in the bathtub 20 without the heating element 60 being exposed or protruding through any surfaces. The heating element 60 is preferably serpentine to extend over a large area of the sidewalls of the bathtub 20.

The heating element 60 is also attached to the outer bottom surface 52 of the bottom floor 50 and conductively heats the inner bottom surface 54 of the bottom floor 50, with the heating element 60 spread evenly throughout the outer bottom surface 52 of the bottom floor 50. The heating element 60 attached to the bottom floor 50 is also preferably serpentine, as shown in phantom in FIG. 2.

There is also a temperature control knob 70 that is situated on top of the electrically heated bathtub 10 to control the amount of heat being generated by the heating element 60. This temperature control knob 70 has relative linear indicia (not shown), which can give a general indication of how much heat is generated by the heating element 60. Temperature control knob 70 is attached to a rheostat or variable resistor that controls the amount of current delivered to the resistive heating elements 60. Alternatively, the bathtub 20 may include a temperature probe (not shown) in the bottom of the tub for sensing water temperature that is connected to a thermostat that can be adjusted by the user U through temperature control knob 70.

A conduit 80 extends from the heating element 60 to a power source to transmit electrical energy from the power source to the heating element 60. The conduit 80 can be a cord that can be connected to a wall outlet, or a cable attached to the power mains through a junction box or the like when the bathtub is installed.

An important feature of the electrically heated hot tub 10 is that the inside wall 30 and the bottom floor 50 are made of heat dispersing ceramic. This heat-dispersing ceramic allows for a safe transfer of heat from the heating element 60 to the user U and water in the electrically heated bathtub 10. A user should also be careful not to let any water go onto the heating element 60 or on the conduit 80.

It is to be understood that the present invention is not limited to the embodiment described above, but encompasses any and all embodiments within the scope of the following claims.

1. An electrically heated bathtub, comprising:
a bathtub with an inside wall, an outside wall and a bottom floor, the inside wall having an outer surface and an inner surface, the outside wall having an outer surface and an inner surface and the bottom floor having an outside bottom surface and an inside bottom surface;
an electrically resistive heating element attached to the outer surface of the inside wall and to the outer bottom surface of the bottom floor;
means for controlling the amount of heat generated by the heating element; and
a conduit having one end electrically connected to the heating element and an opposite end adapted for connection to a source of electrical power.

2. The heated bathtub according to claim 1, wherein said conduit comprises a cord adapted for connection to an electrical outlet.

3. The heated bathtub according to claim 1, wherein said conduit comprises a cable adapted for connection to a power mains junction box.

4. The heated bathtub according to claim 3, wherein said heating element is serpentine in order to distribute heat over a wide area.

5. The heated bathtub according to claim 1, wherein the inside wall is made of heat dispersing ceramic.

6. The heated bathtub according to claim 1, wherein the bottom floor is made of heat dispersing ceramic.
